(19) United States
(12) Patent Application Publication
(10) Pub. No.: US 2022/0069488 A1
(43) Pub. Date: Mar. 3, 2022

(54) HARNESS COMPONENT

(71) Applicant: SUMITOMO WIRING SYSTEMS, LTD., Mie (JP)

(72) Inventor: Yuta INOUE, Mie (JP)

(21) Appl. No.: 17/413,193

(22) PCT Filed: Dec. 5, 2019
(86) PCT No.: PCT/JP2019/047535

§ 371 Date: Jun. 11, 2021

(30) Foreign Application Priority Data
Dec. 14, 2018 (JP) 2018-234260

(51) Int. Cl. H01R 12/51; H01R 12/72; H01R 12/58; H01R 13/422

(52) U.S. Cl. CPC H01R 12/515; H01R 13/4226; H01R 12/58; H01R 12/725

(57) ABSTRACT

A harness component includes a plurality of male terminals, a housing, a plurality of female terminals and a plurality of wires. The plurality of male terminals are connected to a circuit board. The housing includes a plurality of insertion holes and a plurality of female terminal accommodation holes. The male terminals are inserted through the insertion holes. The terminal accommodation holes communicate with the respective insertion holes and include openings on sides opposite to the insertion holes. The plurality of female terminals are inserted and arranged in the respective terminal accommodation holes through the respective openings. The female terminal contacts each male terminal while applying a resilient force in a direction intersecting an axial direction X of the terminal accommodation hole. The plurality of wires are electrically connected to the respective female terminals.

### TECHNICAL FIELD

The present invention relates to a harness component.

### BACKGROUND

A harness component described in Patent Document 1 includes a male connector to be mounted on one side in a thickness direction of a circuit board and a female connector connected to the male connector.

The male connector includes male terminals to be electrically connected to through holes of the circuit board and a male housing made of electrically insulating resin or the like for accommodating the male terminals. The male housing includes a connector fitting portion in the form of a bottomed tube open toward a side opposite to the circuit board. The female connector is fit into the connector fitting portion through the open side. Further, the male terminals are press-fit into a bottom wall of the connector fitting portion from the open side, and electrical contact portions, which are parts of the male terminals, project inside the connector fitting portion.

By fitting the female connector into the connector fitting portion of the male connector, the electrical contact portions and female terminals of the female connector are electrically connected.

### PRIOR ART DOCUMENT

### Patent Document

Patent Document 1: JP 2002-216870 A

### SUMMARY OF THE INVENTION

### Problems to be Solved

The female connector is thought to include the female terminals to be electrically connected to the male terminals and an electrically insulating female housing for accommodating the female terminals. However, in this case, two housing members, i.e. the male housing and the female housing, need to be connected in the harness component described in patent literature 1, which tends to cause an increase in the number of components and enlargement.

The present invention was developed in view of the above problem and aims to provide a harness component capable of reducing the number of components and miniaturization.

### Means to Solve the Problem

One aspect of the present invention is directed to a harness component with a plurality of male terminals to be connected to a circuit board, a housing including a plurality of insertion holes, the respective male terminals being inserted through the insertion holes, and a plurality of terminal accommodation holes communicating with the respective insertion holes, the terminal accommodation holes including openings on sides opposite to the insertion holes, a plurality of female terminals to be inserted and arranged in the respective terminal accommodation holes through the respective openings, the female terminal contacting each male terminal while applying a resilient force in a direction intersecting an axial direction of the terminal accommodation hole, and a plurality of wires electrically connected to the respective female terminals.

### Effect of the Invention

In the harness component of the above aspect, the male terminal is inserted into each insertion hole of the housing and the female terminal is inserted into each of the plurality of terminal accommodation holes formed in the housing. Therefore, an increase in the number of the housing can be prevented and a reduction in the number of components and miniaturization are easily realized.

Further, the male terminal and the female terminal are connected in each terminal accommodation hole. Thus, the male terminal and the female terminal are easily positioned with respect to the housing by inserting the male terminal into the terminal accommodation hole through the insertion hole and inserting the female terminal into the terminal accommodation hole through the opening. Further, since the plurality of female terminals are inserted one by one into the respective terminal accommodation holes of the housing and connected to the male terminals, the rattling of the female terminal in mounting the female terminal into the housing is prevented. Therefore, the productivity of the harness component is easily improved.

Further, the female terminal contacts each male terminal while applying the resilient force in the direction orthogonal to the axial direction of the terminal accommodation hole. Thus, the male terminal and the female terminal can slide against each other in the axial direction. Therefore, even if the wire connected to the female terminal is pulled, this pulling force hardly acts on a joined part of the male terminal and the circuit board since the female terminal and the male terminal slide. Hence, the connectivity of the male terminals and the circuit board is easily improved.

As described above, according to the above aspect, it is possible to provide a harness component capable of reducing the number of components and miniaturization.

### BRIEF DESCRIPTION OF THE DRAWINGS

FIG. 1 is a perspective view of a harness component in one embodiment.

FIG. 2 is a plan view of the harness component mounted on a circuit board in the one embodiment.

FIG. 3 is a section along of FIG. 2.

FIG. 4 is a back view of the harness component in the one embodiment.

FIG. 5 is a section showing functions and effects of the harness component in the one embodiment and showing a state where a male terminal is first mounted and a female terminal is subsequently mounted into a housing.

FIG. 6 is a section showing functions and effects of the harness component in the one embodiment and showing a state where the female terminal is first mounted and the male terminal is subsequently mounted into the housing.

FIG. 7 is a section of the harness component when a retainer is at a partial locking position with respect to the housing in the one embodiment.

### DETAILED DESCRIPTION TO EXECUTE THE INVENTION

### Embodiment

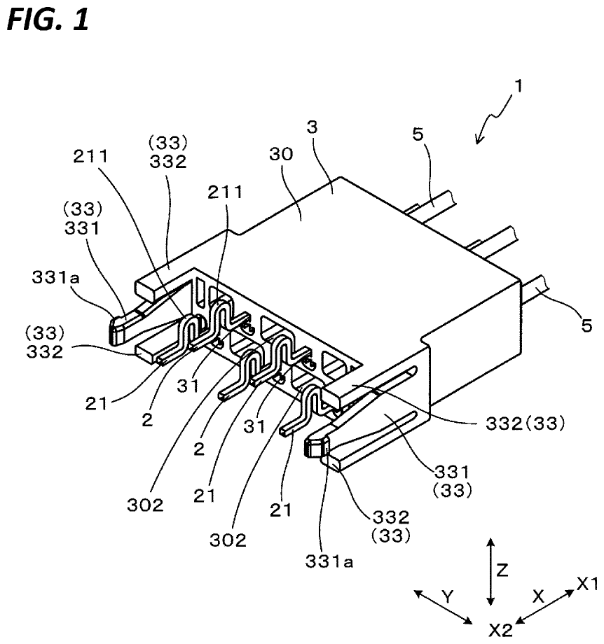

An embodiment of a harness component is described using FIGS. 1 to 7.

The harness component 1 of this embodiment includes a plurality of male terminals 2, a housing 3, a plurality of female terminals 4 and a plurality of wires 5 as shown in FIGS. 1 to 3.

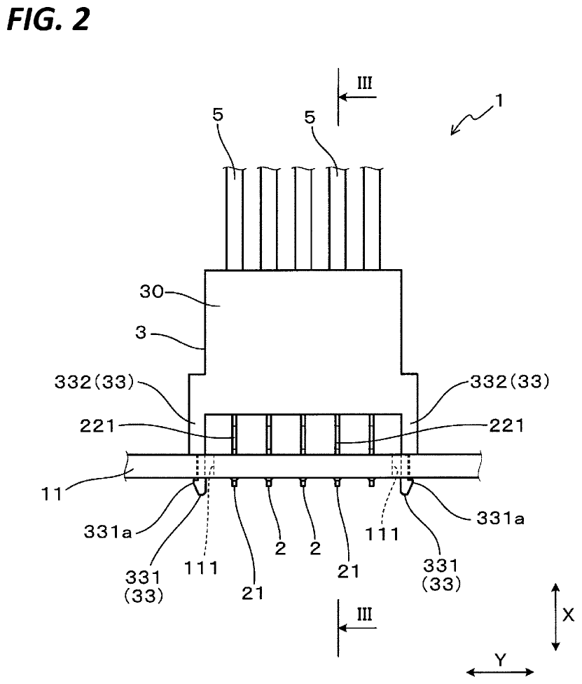

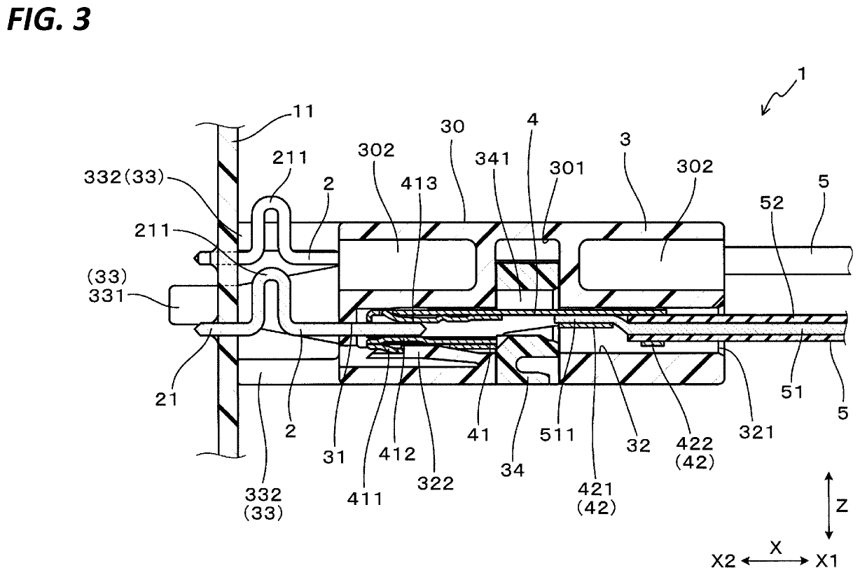

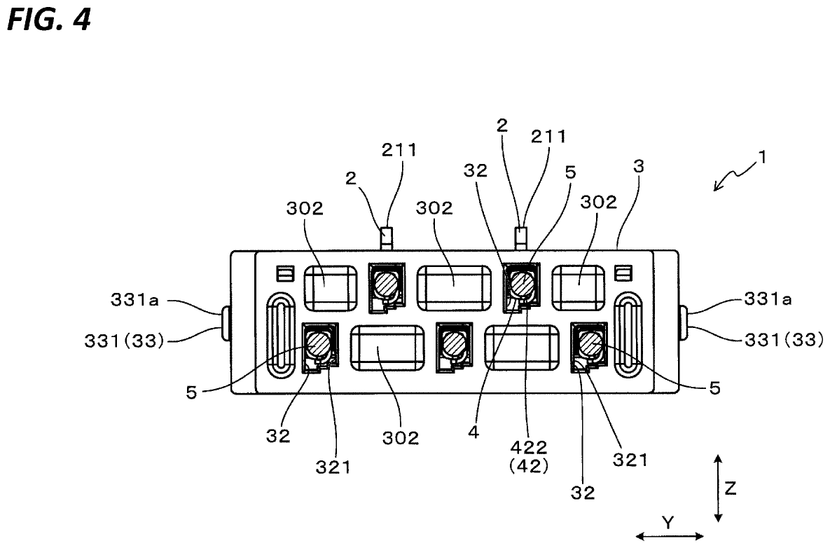

As shown in FIGS. 2 and 3, the plurality of male terminals 2 are connected to a circuit board 11. As shown in FIGS. 1 and 4, the housing 3 includes a plurality of insertion holes 31 and a plurality of terminal accommodation holes 32. As shown in FIG. 3, the male terminal 2 is inserted through the insertion hole 31. Each terminal accommodation hole 32 communicates with each insertion hole 31 and includes an opening 321 on a side opposite to the insertion hole 31.

The plurality of female terminals 4 are inserted and arranged in the respective terminal accommodation holes 32 through the respective openings 321. The female terminal 4 contacts each male terminal 2 while applying a resilient force in a direction intersecting an axial direction X of the terminal accommodation hole 32. The plurality of wires 5 are electrically connected to the respective female terminals 4.

This embodiment is described in detail below.

Hereinafter, the axial direction of the terminal accommodation hole 32 is referred to as an X direction. In the X direction, a side in the terminal accommodation hole 32 where the opening 321 is formed is referred to as an X1 side and a side in the terminal accommodation hole 32 where the insertion hole 31 is formed is referred to as an X2 side.

The harness component 1 electrically relays the circuit board 11 and an unillustrated electronic device such as a control device by connecting parts of the plurality of male terminals 2 projecting from the housing 3 to the circuit board 11 and connecting the plurality of wires 5 connected to the respective female terminals 4 to the electronic device.

The housing 3 is made of electrically insulating resin. As shown in FIG. 1, the housing 3 includes a housing body portion 30 in the form of a rectangular parallelepiped having a thickness in a Z direction orthogonal to the X direction, and housing engaging portions 33 projecting toward the X2 side from the housing body portion 30. As shown in FIG. 4, the housing body portion 30 includes five terminal accommodation holes 32 formed by recessing a surface on the X1 side toward the X2 side.

As shown in FIG. 4, out of the five terminal accommodation holes 32, three terminal accommodation holes 32 are formed on one side in the Z direction and the remaining two terminal accommodation holes 32 are formed on the other side in the Z direction. The five terminal accommodation holes 32 are arranged substantially at equal intervals in a Y direction orthogonal to both the X direction and Z direction. In the Y direction, the terminal accommodation holes 32 disposed on the one side in the Z direction and the terminal accommodation holes 32 disposed on the other side in the Z direction are alternately disposed.

As shown in FIG. 3, the terminal accommodation hole 32 is formed substantially in the entire housing body portion 30 in the X direction. The terminal accommodation hole 32 includes the opening 321 for causing an internal space thereof to be open toward the X1 side in an X1-side end part. Further, the insertion hole 31 is formed in a wall part of the housing 3 disposed on the X2 side in the internal space of the terminal accommodation hole 32.

The male terminal 2 is press-fit into the insertion hole 31 of the housing 3 from the X2 side, and the female terminal 4 is inserted into the terminal accommodation hole 32 through the opening 321 of the housing 3. That is, a mounting direction of the male terminal 2 into the housing 3 (direction toward the X1 side) and a mounting direction of the female terminal 4 into the housing 3 (direction toward the X2 side) are opposite e.

As shown in FIG. 3, a locking lance 322 is formed on an X2-side end part of a side wall of the terminal accommodation hole 32. The locking lance 322 locks the female terminal 4 inserted to a predetermined position of the terminal accommodation hole 32 from the X1 side. In this way, the female terminal 4 is prevented from escaping toward the X1 side of the terminal accommodation hole 32 after being inserted to the predetermined position of the terminal accommodation hole 32.

As shown in FIG. 3, the locking lance 322 is formed to be long in the X direction and can be resiliently deflected in the Z direction. When the female terminal 4 is inserted into the terminal accommodation hole 32, the locking lance 322 is resiliently deflected by being pushed by a locked portion 411 formed on the female terminal 4. The locking lance 322 is deflected in this way, whereby the entrance of the female terminal 4 into the terminal accommodation hole 32 from the X1 side to the X2 side is allowed.

When the female terminal 4 is inserted to the predetermined position of the terminal accommodation hole 32 as shown in FIG. 3, the locked portion 411 of the female terminal 4 is disposed on the X2 side of the locking lance 322 and the locking lance 322 enters the X1 side of the locked portion 411 by a resilient restoring force of the locking lance 322. In this way, the locking lance 322 locks the locked portion 411 of the female terminal 4 from the X1 side of the locked portion 411 to retain the female terminal 4.

As shown in FIG. 3, a retainer arrangement portion 301 recessed from one side toward the other side in the Z direction is formed in a central part in the X direction of the housing body portion 30. A retainer 34 is locked in the retainer arrangement portion 301.

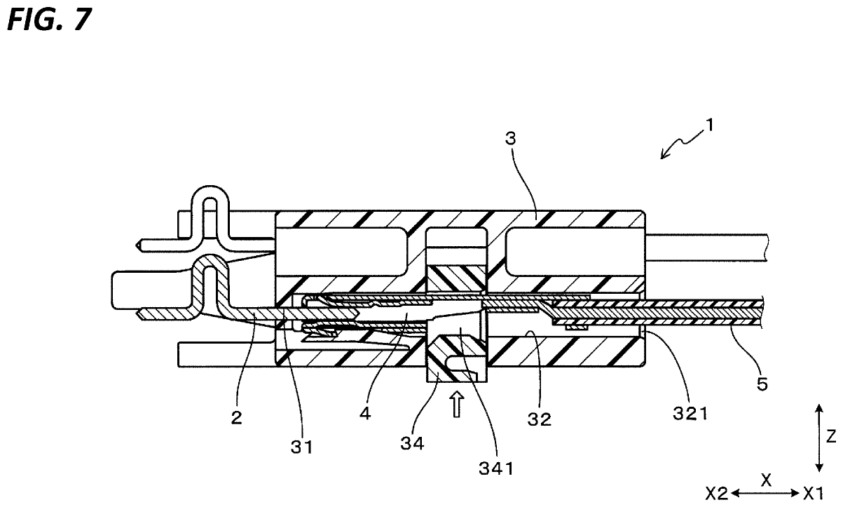

When the retainer 34 is at a partial locking position with respect to the housing 3 as shown in FIG. 7, the female terminals 4 are allowed to be mounted in and withdrawn from the terminal accommodation holes 32 of the housing 3. Further, when the retainer 34 is at a full locking position with respect to the housing 3 as shown in FIG. 3, the female terminals 4 inserted into the terminal accommodation holes 32 are retained by the retainer 34.

As shown in FIG. 3, the retainer 34 includes five insertion holes 341 penetrating in the X direction. The respective insertion holes 341 are disposed in the mutually different terminal accommodation holes 32. When the retainer 34 is at the partial locking position and the full locking position with respect to the housing 3 as shown in FIGS. 3 and 7, the insertion holes 341 of the retainer 34 communicate with the terminal accommodation holes 32.

The insertion holes 341 are formed to have such a diameter that the female terminals 4 can be inserted in the X direction. When the retainer 34 is at the partial locking position with respect to the housing 3 as shown in FIG. 7, center axes of the insertion holes 341 substantially coincide with those of the terminal accommodation holes 32. Therefore, when the retainer 34 is at the partial locking position with respect to the housing 3, the female terminals 4 are allowed to be mounted into and withdrawn from the terminal accommodation holes 32.

By pushing the retainer 34 at the partial locking position toward a back side of the retainer arrangement portion 301 of the housing 3 as shown in FIG. 7, the retainer 34 is disposed at the full locking position as shown in FIG. 3. When the retainer 34 is at the full locking position, parts of the retainer 34 enter spaces on the X1 sides of later-described tubular portions 41 of the female terminals 4 inserted to the predetermined positions of the terminal accommodation holes 32. In this way, when the retainer 34 is at the full locking position, the retainer 34 locks the tubular portions 41 of the female terminals 4 from the X1 side of the tubular portions 41 to prevent the escape of the female terminals 4 from the terminal accommodation holes 32.

Further, as shown in FIGS. 1 and 4, both surfaces in the X direction of the housing body portion 30 are recessed in the X direction at positions adjacent to the terminal accommodation holes 32 in the Z direction and Y direction to form lightening portions 302. As shown in FIG. 3, the lightening portions 302 are formed from the end surfaces in the X direction of the housing body portion 30 to positions before the retainer arrangement portion 301. The lightening portions 301 function to reduce the weight of the housing 3, prevent the formation of sinks in the housing 3 and the like.

As shown in FIGS. 1 and 2, the housing engaging portions 33 are integrally formed to the housing body portion 30. That is, the entire housing 3 including the housing engaging portions 33 and the housing body portion 30 is constituted by one member and is not formed, for example, by joining a plurality of members. The housing engaging portions 33 are formed from both ends in the Y direction of the housing body portion 30 on the X2 side.

As shown in FIG. 1, the housing engaging portion 33 includes a housing flexible piece 331 and housing restricting portions 332. The housing flexible piece 331 is formed from a central part in the Z direction of each of both ends in the Y direction of the housing body portion 30 on the X2 side.

As shown in FIG. 1, the housing flexible piece 331 is in the form of a plate having a thickness in the Y direction and long in the X direction. The housing flexible piece 331 is configured to be resiliently deflectable in the Y direction. As shown in FIGS. 1 and 2, a pair of the housing flexible pieces 331 include engaging projections 331a formed to project toward sides away from each other in the Y direction on X1-side end parts.

As shown in FIG. 2, the pair of housing flexible pieces 331 are inserted into board engagement holes 111 formed to penetrate through the circuit board 11 in the Z direction. Here, when the pair of engaging projections 331a pass through the board engagement holes 111, the pair of housing flexible pieces 331 are inserted into the board engagement holes 111 while being deflected in directions toward each other along the Y direction. When the engaging projections 331a pass through the board engagement holes 111 and are disposed on the X2 side of the circuit board 11, the pair of housing flexible pieces 331 are deformed toward sides away from each other in the Y direction by resilient restoring forces and return to initial shapes. In this way, the engaging projections 331a are engaged with peripheral parts of the board engagement holes 111 in the circuit board 11 in the X direction to prevent the escape of the housing 3 from the board engagement holes 111.

As shown in FIGS. 1 and 3, the housing restricting portions 332 are formed on both sides in the Z direction of the housing flexible piece 331. The housing restricting portions 332 are formed in parallel to the housing flexible piece 331. The housing restricting portions 332 are formed to be shorter in the X direction than the housing flexible piece 331 and end parts on the X2 side are formed to be located closer to the X1 side than an end part on the X2 side of the housing flexible piece 331.

As shown in FIGS. 1 and 3, with the pair of housing flexible pieces 331 engaged with the board engagement holes 111 of the circuit board 11, surfaces on the X2 side of the housing restricting portions 332 are facing a surface on the X1 side of the circuit board 11. In this way, with the pair of housing flexible pieces 331 engaged with the board engagement holes 111 of the circuit board 11, the circuit board 11 is sandwiched between the housing restricting portions 332 and the engaging projections 331a of the housing flexible pieces 331. Thus, with the pair of housing flexible pieces 331 engaged with the board engagement holes 111 of the circuit board 11, a displacement in the X direction of the housing 3 with respect to the circuit board 11 is limited by the housing restricting portions 332 and the engaging projections 331a of the housing flexible pieces 331.

As shown in FIGS. 1 to 3, the male terminal 2 is made of a pin-shaped (column-shaped) metal material. An X1-side end part of the male terminal 2 is inserted into the terminal accommodation hole 32 through the insertion hole 31. Further, an outer terminal portion 21 formed on the X2 side of the male terminal 2 projects toward the X2 side from the insertion hole 31.

As shown in FIGS. 1 and 3, the outer terminal portion 21 includes a crank portion 211 bent in a direction intersecting the X direction and stretchable in a thickness direction (X direction) of the circuit board 11. The crank portion 211 is formed by bending a central part of the outer terminal portion 21 into a U shape projecting toward the one side in the Z direction. Parts of the male terminal 2 other than the crank portion 211 are formed into a pin shape (column shape) straight in the X direction.

As shown in FIG. 1, at least a cross-sectional shape of the male terminal 2 orthogonal to a longitudinal direction of the outer terminal portion 21 to be connected to the circuit board 11 is a convex polygonal or circular shape. The convex polygonal shape means a polygonal shape, all the inner angles of which are respectively below 180°. In this embodiment, the male terminal 2 has a substantially square cross-sectional shape orthogonal to a longitudinal direction of the male terminal 2 in the entirety thereof. A part of the outer terminal portion 21 on the X2 side of the crank portion 211 is inserted into the through hole of the circuit board 11 in the X direction and soldered to the circuit board 11.

As shown in FIG. 3, the female terminal 4 includes the tubular portion 41 and a crimping portion 42. The tubular portion 41 is formed by bending a plate-like conductive member into a rectangular tube. The tubular portion 41 is so configured that the male terminal 2 is insertable thereinto through an X2-side end part of the tubular portion 41. When the retainer 34 is at the full locking position with respect to the housing 3, a part of the retainer 34 is disposed on the X1 side of the tubular portion 41 and the male terminal 2 is retained by the contact of the tubular portion 41 with the retainer 34 in the X direction. Note that, with the female terminal 4 disposed at the predetermined position of the terminal accommodation hole 32, the tubular portion 41 of the female terminal 4 is disposed at a position slightly separated from the retainer 34 toward the X2 side.

As shown in FIG. 3, the tubular portion 41 includes a raised portion 412 raised toward the male terminal 2 in the Z direction and configured to contact the male terminal 2, and a resilient contact piece 413 facing the raised portion 412 and configured to resiliently contact the male terminal 2 from a side opposite to the raised portion 412.

The resilient contact piece 413 is configured to be resiliently deflectable in the Z direction. When the male terminal 2 is inserted into the tubular portion 41, the resilient contact piece 413 is pushed by this male terminal 2 to be deflected toward the side opposite to the raised portion 412 in the Z direction. In this way, the male terminal 2 is resiliently sandwiched between the raised portion 412 and the resilient contact piece 413. The male terminal 2 is configured to be slidable in the X direction with respect to the tubular portion 41 in a state resiliently sandwiched between the raised portion 412 and the resilient contact piece 413. That is, the male terminal 2 is not fixed to the tubular portion 41.

As shown in FIG. 3, the female terminal 4 is formed with the locked portion 411 on a side in the Z direction opposite to a side where the resilient contact piece 413 facing the raised portion 412 is formed. The locked portion 411 is formed toward the X1 side from the X2-side end part of the tubular portion 41 and formed to project more toward the side opposite to the raised portion 412 in the Z direction toward the X1 side. An X1-side end part of the locked portion 411 is locked by the locking lance 322.

As shown in FIG. 3, the crimping portion 42 is crimped to an end part of the wire 5. The wire 5 includes a conductive portion 51 having conductivity and an electrically insulating coating portion 52 covering the conductive portion 51. The end part of the wire 5 serves as an exposed conductive portion 511 in which the conductive portion 51 is exposed from the coating portion 52. The crimping portion 42 includes a first crimping portion 421 to be crimped to the exposed conductive portion 511 and a second crimping portion 422 formed on the X1 side of the first crimping portion 421 and to be crimped to an end part of the coating portion 52.

Next, functions and effects of this embodiment are described.

In the harness component 1 of this embodiment, the male terminal 2 is inserted through each insertion hole 31 of the housing 3 and the female terminal 4 is inserted into each of the plurality of terminal accommodation holes 32 formed in the housing 3. Thus, an increase in the number of the housing 3 can be prevented and a reduction in the number of components and miniaturization are easily realized.

Further, the male terminal 2 and the female terminal 4 are connected in each terminal accommodation hole 32. Thus, the male terminal 2 and the female terminal 4 are easily positioned with respect to the housing 3 by inserting the male terminal 2 into the terminal accommodation hole 32 through the insertion hole 31 and inserting the female terminal 4 into the terminal accommodation hole 32 through the opening 321. Further, since the plurality of female terminals 4 are inserted one by one into the respective terminal accommodation holes 32 of the housing 3 and connected to the male terminals 2, the rattling of the female terminal 4 in mounting the female terminal 4 into the housing 3 is prevented. Therefore, the productivity of the harness component 1 is easily improved.

Further, the female terminal 4 contacts each male terminal 2 while applying a resilient force in a direction orthogonal to the axial direction of the terminal accommodation hole 32. Thus, the male terminal 2 and the female terminal 4 can slide against each other in the X direction. Therefore, even if the wire 5 connected to the female terminal 4 is pulled, this pulling force hardly acts on a joined part of the male terminal 2 and the circuit board 11 since the female terminal 4 and the male terminal 2 slide. Hence, the connectivity of the male terminals 2 and the circuit board 211 is easily improved.

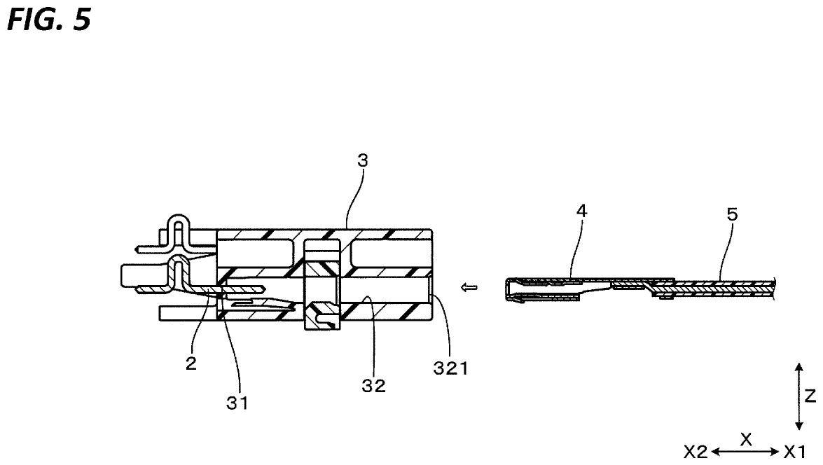

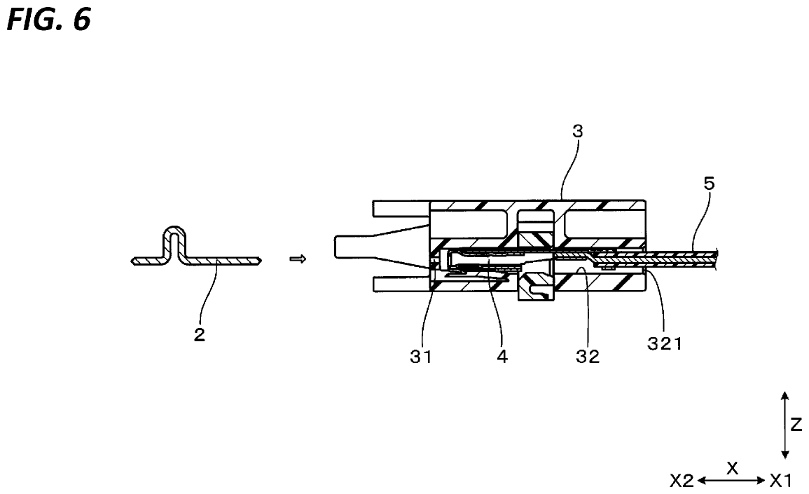

Further, the male terminal 2 is press-fit into the insertion hole 31 of the housing 3 from a side in the terminal accommodation hole 32 opposite to a side where the opening 321 is formed, and the female terminal 4 is inserted into the terminal accommodation hole 32 through the opening 321 of the housing 3. That is, the mounting direction of the male terminal 2 into the housing 3 (direction toward the X1 side) and the mounting direction of the female terminal 4 into the housing 3 (direction toward the X2 side) are opposite. Thus, in assembling the harness component 1, it is possible to press-fit the male terminals 2 into the insertion holes 31 and subsequently mount the female terminals 4 into the terminal accommodation holes 32 through the openings 321 as shown in FIG. 5 and to mount the female terminals 4 into the terminal accommodation holes 32 through the openings 321 and subsequently press-fit the male terminals 2 into the insertion holes 31 as shown in FIG. 6. Thus, a degree of freedom in an assembling process of the harness component 1 can be improved. Further, since the male terminals 2 are fixed to the insertion holes 31 by press-fitting, it is not necessary to separately provide a mechanism for fixing the male terminals 2 to the housing 3. Therefore, the productivity of the harness component 1 is easily improved.

Further, the outer terminal portion 21 of the male terminal 2 projecting from the insertion hole 31 toward the side opposite to the opening 321 includes the crank portion 211 bent in the direction intersecting the X direction and stretchable in the thickness direction of the circuit board 11. Thus, for example, even if an external force is applied to the harness component 1 connected to the circuit board 11, the generation of a stress in the joined part of the outer terminal portion 21 and the circuit board 11 can be suppressed by the crank portion 211 stretching in the X direction.

Here, the crank portions 211 have a bent shape. Thus, for example, if the housing 3 is manufactured by insert molding with the male terminals 2 arranged inside a mold for the housing 3, the crank portions 211 serve as obstacles and it is difficult to remove the mold when the mold is removed after molding. Thus, the mold needs to be provided with a special structure such as a slide mechanism and the productivity of the entire harness component 1 is reduced. On the other hand, in this embodiment, the male terminals 2 are fixed to the housing 3 by press-fitting. Thus, a reduction in the productivity of the harness component 1 caused by providing the male terminals 2 with the crank portions 211 can be suppressed.

Further, the housing 3 integrally includes the housing engaging portions 33 to be engaged with the circuit board 11. Thus, the male terminals 2 and the circuit board 11 can be joined such as by soldering after the housing 3 is engaged with the circuit board 11 at the housing engaging portions 33 and relative positions of the housing 3 and the circuit board 11 are fixed. Furthermore, since the housing 3 integrally includes the housing engaging portions 33, the number of components is not increased even if the housing engaging portions 33 are provided.

Further, the retainer 34 is locked in the housing 3. The retainer 34 allows the female terminals 4 to be mounted into and withdrawn from the terminal accommodation holes 32 of the housing 3 when being located at the partial locking position with respect to the housing 3, and retains the female terminals 4 inserted into the terminal accommodation holes 32 when being at the full locking position with respect to the housing 3. Therefore, the detachment of the female terminals 4 from the housing 3 is easily suppressed even in a configuration for holding both the male terminals 2 and the female terminals 4 by one housing 3.

Further, the outer terminal portion 21 of the male terminal 2 to be soldered to the circuit board 11 has a convex polygonal or circular cross-sectional shape orthogonal to the longitudinal direction of the outer terminal portion 21. Thus, the formation of voids in solder can be prevented, for example, as compared to the case where the outer terminal portion 21 is formed as a tab-like terminal formed by bending a plate-like metal member to have a U-shaped cross-section. That is, if the outer terminal portion 21 is formed into a tab shape, air remains in a space surrounded by the outer terminal portion 21 having a U-shaped cross-section and voids are easily formed in the solder. On the other hand, by forming the outer terminal portion 21 to have a convex polygonal or circular cross-section, there is no space surrounded by the outer terminal portion 21 in the cross-section of the outer terminal portion 21 orthogonal to the X direction, wherefore the formation of voids in the solder can be suppressed.

As described above, according to this embodiment, it is possible to provide a harness component capable of reducing the number of components and miniaturization.

The present invention is not limited to the above embodiment and can be applied to various embodiments without departing from the gist thereof.

1. A harness component, comprising:
a plurality of male terminals to be connected to a circuit board;
a housing including a plurality of insertion holes, the respective male terminals being inserted through the insertion holes, and a plurality of terminal accommodation holes communicating with the respective insertion holes, the terminal accommodation holes including openings on sides opposite to the insertion holes;
a plurality of female terminals to be inserted and arranged in the respective terminal accommodation holes through the respective openings, the female terminal contacting each male terminal while applying a resilient force in a direction intersecting an axial direction of the terminal accommodation hole; and
a plurality of wires electrically connected to the respective female terminals,
wherein:
the male terminals are inserted into through holes of the circuit board and welded to the circuit board,
an outer terminal portion of the male terminal projecting from the insertion hole toward a side opposite to the opening includes a crank portion bent in a direction intersecting the axial direction and stretchable in a thickness direction of the circuit board, and
the male terminal is press-fit into the insertion hole of the housing from a side in the terminal accommodation hole opposite to a side where the opening is formed.

2. The harness component of claim 1, wherein the female terminal is inserted into the terminal accommodation hole through the opening of the housing.

3. (canceled)

4. The harness component of claim 1, wherein the housing integrally includes a housing engaging portion to be engaged with the circuit board.

5. The harness component of claim 1, wherein a retainer is locked in the housing, and the retainer allows the female terminals to be mounted into and withdrawn from the terminal accommodation holes of the housing when being at a partial locking position with respect to the housing and retains the female terminals inserted into the terminal accommodation holes when being at a full locking position with respect to the housing.
